(19) United States
(12) Patent Application Publication
(10) Pub. No.: US 2008/0016532 A1
(43) Pub. Date: Jan. 17, 2008

(54) Method and system for adjusting audio/video effects

(75) Inventors: Houng-Jyh Wang, Taipei City (TW); Hsiu-Hao Tsai, Tainan City (TW)

Correspondence Address: BIRCH STEWART KOLASCH & BIRCH, PO BOX 747, FALLS CHURCH, VA, 22040-0747, US

(73) Assignee: Teco Electric & Machinery Co., Ltd.

(21) Appl. No.: 11/633,482

(22) Filed: Dec. 5, 2006

(30) Foreign Application Priority Data
Jul. 11, 2006 (TW) 95125315

(51) Int. Cl. H04N 7/173; H04N 5/445; G06F 13/00

(52) U.S. Cl. 725/45; 725/100; 725/131; 725/46

(57) ABSTRACT

Disclosed is a method and system for adjusting audio/video effect. The system comprises a tuner with demodulator, a DTV decoder, an audio/video mapping unit, and an audio/video processing unit. The method comprises the steps of receiving a digital TV signal; transmitting the service information signal in the digital TV signal to the audio/video mapping unit. Then, the mapping unit is used for comparing the service information signal with parameter tables to obtain at least one audio/video parameter value. Finally, the audio/video processing unit adjusts the digital TV signal based on the audio/video parameter value.

### RELATED APPLICATIONS

The present application is based on, and claims priority from, Taiwan Application Serial Number 95125315, filed Jul. 11, 2006, the disclosure of which is incorporated by reference herein in its entirety.

### BACKGROUND

1. Field of Invention

The present invention relates to a method and a system for adjusting audio/video effects. More particularly, the present invention relates to a method and a system for auto adjusting audio/video effects by the service information.

2. Description of Related Art

TV program signals have become digitized. Digital signal advantages include easy compression and immunity to interference from weather and radio frequencies. The digital TV (DTV) signal described above uses of a small channel bandwidth, and frees up space for more digital channels. Moreover, DTV has superior image and audio quality and better reception than analog signals.

A service information (SI) signal exists in DTV systems. The service information signal is an additional signal that contains TV program information and so on with the DTV signal. The electronic program guide (EPG) service is based on the service information. The EPG service is used to review program schedules on the TV screen directly.

Moreover, the EGP service provides program information on the TV screen, such as program title, program introduction, broadcast region. Furthermore, if the DTV signal provider provides more information for EPG service, then the users can view the program type and program rating on the screen. FIG. 1 is a schematic diagram of a simple EPG service table. The table shows program data, program time, program title, program content, program type, and program rating on the screen. The information of the EPG service is based on the service information, thus, the abundant service information provides plentiful EPG services.

The variety of programs requires different audio/video parameters to enhance the effect of the program. For example, movies usually have many dark scenes and the display apparatus must therefore increase the contrast and reduce the brightness to show the scene details. Audio parameters are also important. To obtain the best result, different sound effects and sound stage parameters are used when a movie or concert is watched. Accordingly, both the audio and video parameters must be adjusted according to the program type to obtain the best effects for the TV program.

To satisfy the many program types, the display devices always have a plurality of audio and video modes installed, such as movie mode and normal mode. However, too many choices could confuse the users. If the mode choices are too few, the user cannot feel good when watching a TV program.

In addition, when actually watching TV, the audio and video modes are changed infrequently because there are too many TV program types, and display mode selection is too complex.

Therefore, it is desirable to auto adjust the audio and video display parameters to match the TV program types.

### SUMMARY

In accordance with the foregoing and other objectives of the present invention, an auto adjusting audio/video parameters system thereof is provided. The system at least comprises a tuner with demodulator, a DTV decoder, an audio/video mapping unit, an audio/video processing unit, and at least one parameter table.

The method of auto adjusting audio/video parameters comprises the steps of receiving a DTV signal by the tuner with demodulator, and demodulating the DTV signal. The demodulated DTV signal is then decoded by the DTV decoder to become a digital video signal, a digital audio signal, and a service information signal. The service information signal is transmitted to the audio/video mapping unit, and compared with the parameter table to retrieve at least one audio/video parameter value. After processing the audio/video parameter values, the audio/video processing unit receives the processed audio/video parameter values and adjusts the digital audio/video signal based on the processed audio/video parameter values to display the digital audio/video signal with the best mode.

The embodiment of the present invention adds the audio/video mapping unit to a DTV system, and the DTV system further comprises at least one built-in parameter table. Compare the parameter tables with the service information which is in the DTV signal, the audio/video mapping unit can obtain the audio/video parameter values. So an audio/video processing unit can auto adjust the audio/video signal based on the audio/video parameter values and display the digital audio/video signal with the best mode.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of a simple EPG service table;

FIG. 2 is a schematic diagram of a system flow chart of the embodiment of the present invention;

FIG. 3 is a schematic diagram of a simple service information table;

FIG. 4 is a schematic diagram of an audio parameter table of one embodiment of the present invention;

FIG. 5 is a schematic diagram of a video parameter table of one embodiment of the present invention;

FIG. 6 is a schematic diagram of a working flow chart of the audio/video mapping unit of one embodiment of the present invention;

FIG. 7 is a schematic diagram of an audio parameter table of another embodiment of the present invention;

FIG. 8 is a schematic diagram of a video parameter table of another embodiment of the present invention.

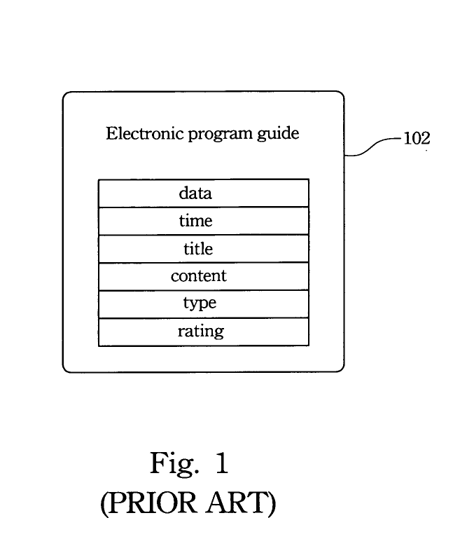

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The following provides a detailed description of a method and a system for auto adjusting audio/video effects in DTV system. The version of the invention adds an audio/video mapping unit, at least one built-in parameter table, and at least one predetermined function. The audio/video mapping unit compares the service information with the parameter table to retrieve the audio/video parameter values, and substitutes the audio/video parameters into the predetermined functions to obtain suitable values. The suitable values are transmitted to the audio/video processing unit to adjust the digital audio/video signal to display the digital audio/video signal in the best mode.

The audio/video mapping unit can be a program, and achieved through software or firmware. Moreover, the audio/video mapping unit can also be designed as a circuit, and realized in hardware, for example, an IC chip. The parameter tables and the predetermined functions can be designed as the software, hardware, or stored in a nonvolatile storage module. Someone skilled in the art could design the variant audio/video mapping unit, parameter tables, and predetermined functions for the different display apparatus, and audio/video processing units to achieve the best audio/video display quality.

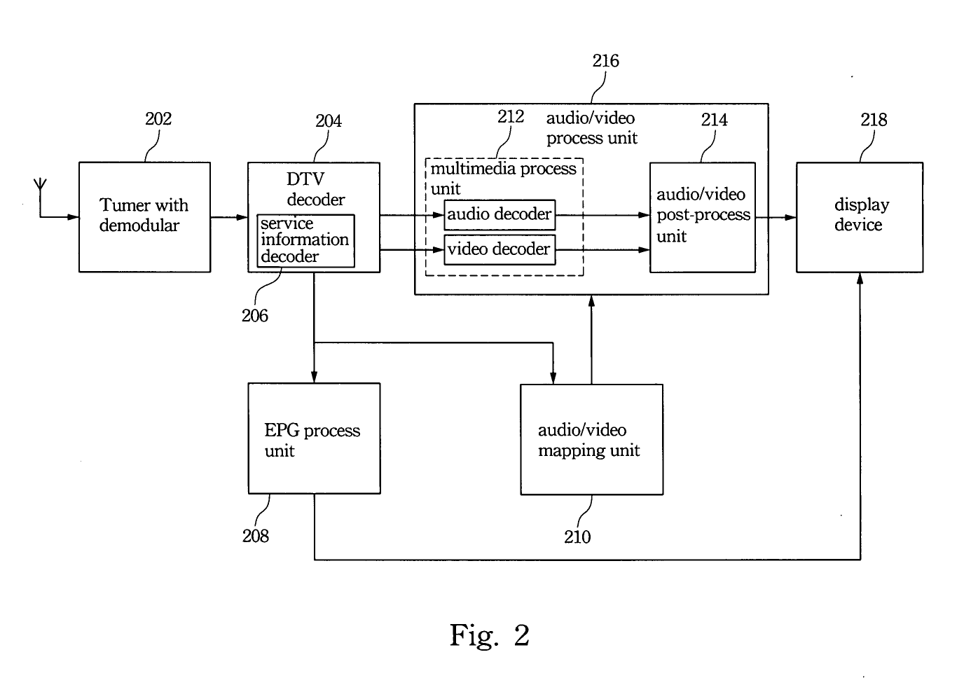

Please refer to FIG. 2. FIG. 2 is a schematic diagram of a system flow chart of the embodiment of the present invention. The system contains a tuner with demodulator 202, a DTV decoder 204, an EPG processing unit 208, an audio/video mapping unit 210, an audio/video processing unit 216, and a display device 218. The DTV decoder 204 further comprises a service information decoder 206. The audio/video processing unit 216 further comprises a multimedia processing unit 212, and an audio/video post-processing unit 214. The multimedia processing unit 212 contains an audio decoder and a video decoder.

After the tuner with demodulator 202 receives the digital TV signal containing a service information signal, the digital TV signal is demodulated. Then the demodulated digital TV digital signal is transmitted to the DTV decoder 204. Subsequently, the DTV decoder 204 decodes the demodulated digital TV signal to a digital video signal, and a digital audio signal. Moreover, the service information decoder 206 which is in the DTV decoder 204 can separate the digital TV signal into the service information signal and the digital audio/video signal. Therefore, the digital TV signal becomes three different signals, the service information signal, the digital audio signal, and the digital video signal.

Subsequently, the digital video signal and the digital audio signal are transmitted to the audio/video processing unit 216, and processed further. The audio/video processing unit 216 contains a multimedia processing unit 212 and a video/audio post-process 214. The multimedia processing unit 212 is built by the DTV chip design company, and used to decode the digital video signal and the digital audio signal to a signal which can be displayed on the screen. To emphasize the product specification, the assembly company of the DTV always builds the audio/video post-processing unit 214 to process the signal from the multimedia processing unit 212, and enhance the audio/video effect.

In addition, the service information is transmitted to the EPG processing unit 208. The EPG processing unit 208 transforms the service information to an EPG and shows the EPG on the display device 218. Therefore, the users could know the information of the TV program through the EPG on the screen.

In the embodiment of the present invention, the service information is still transmitted to the audio/video mapping unit 210 by an Inter-Integrated Circuit or other interface. The contents of the service information is decided by the digital TV provider, but the digital TV standards requests that the contents of the service information at least contains the basic information of this program and the next program, for example, program title. Therefore, the audio/video mapping unit 210 can decide the program type based on the service information, and compare the program type information with the built-in DTV parameter table. The audio/video mapping unit 210 retrieves the audio/video parameter values from the parameter table and substitutes the audio/video parameter values into the predetermined functions to obtain suitable values. The values are transmitted to the audio/video processing unit 216 and used to adjust the digital audio/video signal to enhance the effects of the audio/video signal. On the other hand, the system could automatically adjust the audio/video parameters to the best display mode based on the service information.

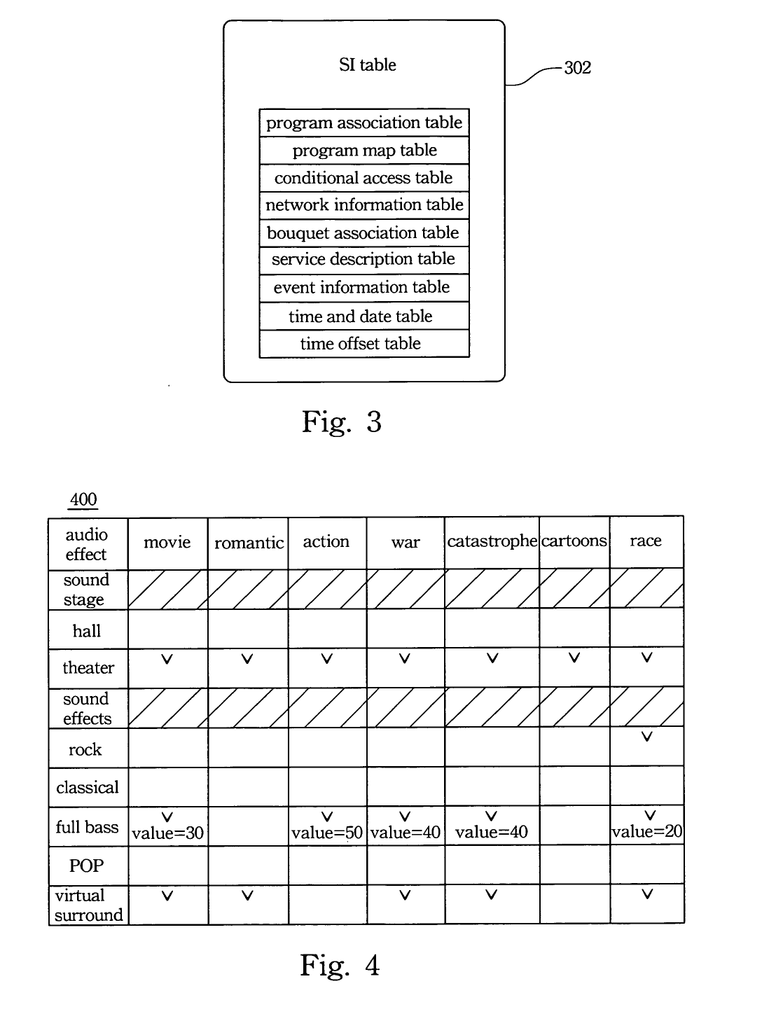

FIG. 3 is a schematic diagram of a simple service information table. This table comprises some information, such as program association table, program map table, conditional access table, network information table, bouquet association table, service description table, event information table, time and date table, and time offset table.

Information contained in the service information table has specific information of programs, networks, or systems. For example, the program association table contains program titles and program types; time and data tables contains present time and TV show schedule; time offset tables contains the information of the daylight saving time. Therefore, the audio/video mapping unit 210 can decide the present program type using the service information table, and retrieve the audio/video parameter values from the parameter tables. If the service information contains more information, then the audio/video mapping unit 210 will receive more information, and determine the suitable parameters based on the receieved information.

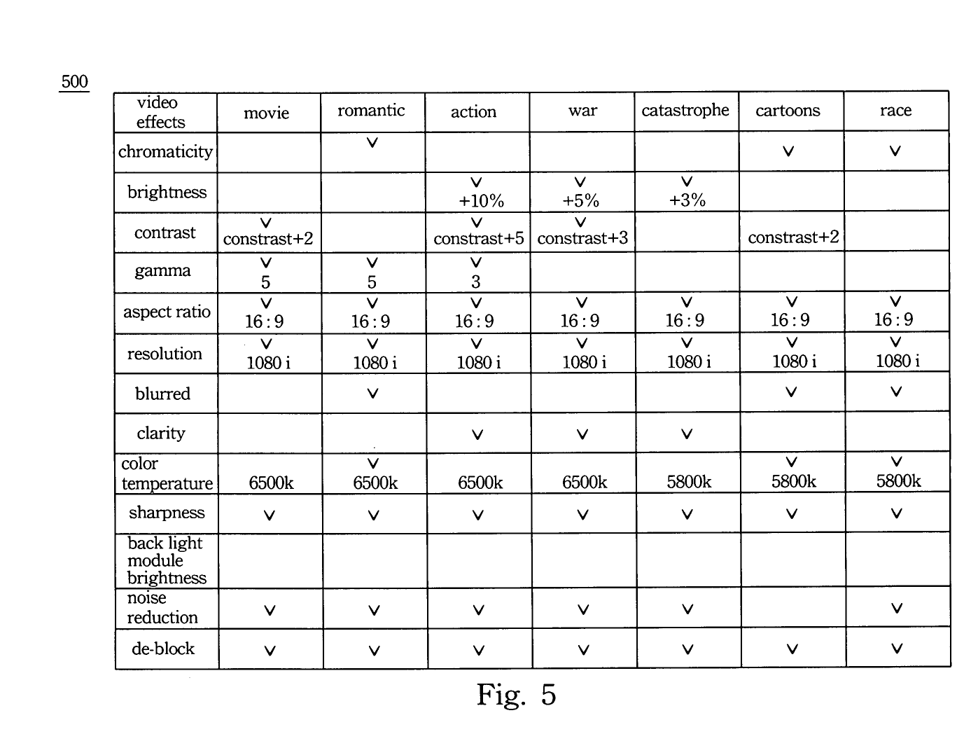

There are two categories of parameter tables in the embodiment of the present invention, video and audio. Please refer to FIG. 4 and FIG. 5. FIG. 4 is a schematic diagram of an audio parameter table of one embodiment of the present invention, and FIG. 5 is a schematic diagram of a video parameter table of one embodiment of the present invention. The audio parameters in FIG. 4 have sound stage such as Hall, and Theater, and sound effects such as Rock, Classical, POP, Virtual Surround, and Full Bass. The video parameters in FIG. 5 have Chromaticity, Brightness, Gamma, Contrast, Color temperature, Sharpness, Resolution, Aspect Ratio, Back Light Module Brightness, Noise Reduction, and De-block parameters. Every parameter table has a plurality of modes, for example, action, cartoons, and the parameter values are different in the various modes to match the variety of programs. Each company could decide what variety of parameter tables, parameters, parameter values, and profiles they will use.

In the embodiment of the present invention, the checks in the parameter tables indicate whether the parameters are activated or not. Furthermore, some of the active parameters have different parameter values according to the requirements. Therefore, the audio/video effect modulation depends on whether the parameters are activated or not and the level of the parameter values with the various modes. Moreover, the method for adjusting the audio/video effect could have various designs according to the requirement. For example, the parameters value could be substituted into a predetermined function to obtain an adjustment and then adjust the audio/video effect based on the adjustment.

The different TV components bring various display effects. For example, the different series of products in one company have different components, such as various panels, audio/video processing units, thus, results in the contrast, chromaticity, and other features of the display apparatus are different. Even display models in the same series of products may not have identical features. However, the variation of the display feature is due to the variation of hardware, not the signal source. Therefore, the built-in audio/video parameters are not suitable for all display apparatus, and the users cannot obtain the best effect on display apparatus. Therefore besides the built-in parameter tables and the parameter values of the parameter tables, the embodiment of the invention further comprises at least one predetermined function.

The audio/video mapping unit, the parameter tables, and the parameter values of the parameter tables can be suitable for most of display apparatus. For different display apparatus features, the predetermined functions must be fine tuned for the best display effects. An advantage of the embodiment is that a DTV company has a wide range of display apparatus on which to apply the identical audio/video mapping units and parameter tables for various series of products.

Take the gamma correction as an example, this parameter is used to adjust the relative brightness of the scene. If the scene is too dark, then the gamma value can increase to show the detail in the dark scene. The audio/video mapping unit on the TV can compare the TV program service information with the compatible parameters and independently determine a gamma value for the TV program. However, every display apparatus has different features. If the audio/video signal adjustment is based on the unique gamma value that corresponds to a specific mode, then not all display apparatus models will show the best audio/video signals. Therefore, the embodiment of the present invention has at least one built-in predetermined function to fine-tune the gamma value. For example, the gamma value can be adjusted to a suitable level for each display apparatus.

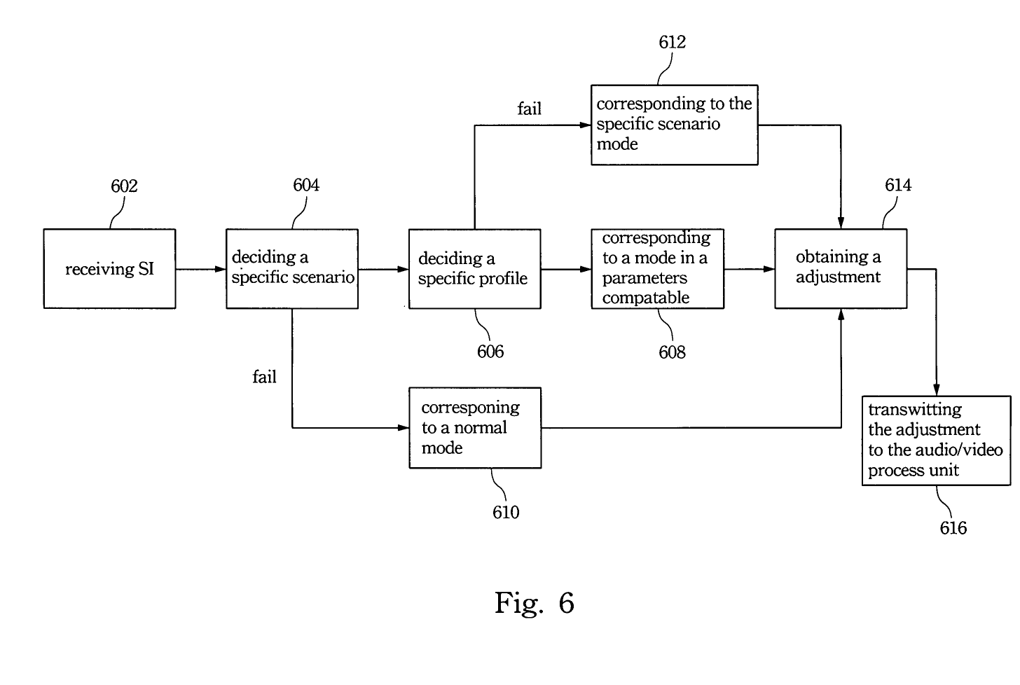

The following describes how the audio/video mapping unit determines the correct profile and retrieves the parameter values. Please refer to FIG. 6, it is a schematic diagram of a working flow chart of the audio/video mapping unit of one embodiment of the present invention. In the embodiment of the present invention, besides the audio/video parameter tables, the system further comprise many categories of scenarios such as movies and sports. Below the scenarios, the scenarios further contain many profile categories such as action or war. On the other hand, the scenarios are general classifications of the TV program, and the audio/video parameters are classified by the scenarios. The profiles are a detailed classification of the TV program, and correspond to the mode in the scenarios of the audio/video parameter table.

In step 602, the audio/video mapping unit 210 receives the service information signal. In step 604, the audio/video mapping unit 210 decides a specific scenario based on the program information in the information signal. In step 606, the audio/video mapping unit 210 decides the specific profile, which in the specific scenario, is based on the program information of the information signal. In step 608, the audio/video mapping unit 210 retrieves the audio/video parameter values from the parameter table corresponded to the specific profile. In step 614, the audio/video parameter values are substituted to the predetermined functions to obtain adjustments. In step 616, the adjustments are transmitted to the audio/video processing unit 216, and the audio/video processing unit 216 adjusts the digital audio/video signal based on the adjustments.

In step 604, if the program information of the service information is not enough, the audio/video mapping unit 210 cannot decide the specific scenario, then go to the step 610, the audio/video mapping unit 210 decides a predetermined normal mode in the parameter tables and goes to step 614. In step 606, if the program information of the service information is not enough to decide the specific profile, then goes to step 612, the audio/video mapping unit 210 decides the specific scenario mode in the parameter tables and goes to step 614.

For details describing the application of the present invention, there are two embodiments described with different TV program categories.

### First Embodiment

Please refer to FIG. 4, FIG. 5, and FIG. 6 together. This embodiment presumes that the digital TV program is a movie. More particularly, the digital TV program is an exciting action movie. In step 602, the audio/video mapping unit receives the service information signal. In step 604, the audio/video mapping unit decides that the digital TV program is a movie scenario based on the program information of the service information, and retrieves the audio/video parameter tables 400, 500 of the movie scenario. There are many profiles in the movie scenario, for example, action, war, and romantic. In step 606, the audio/video mapping unit further decides that the digital TV program is an action movie profile based on the program information. Therefore, in step 608, the audio/video mapping unit retrieves the action mode audio/video parameter values from the audio/video parameter tables of the movie scenario. In step 614, the action movie mode audio/video parameter values are substituted to the predetermined functions to obtain the adjustments. Finally, the audio/video processing unit adjusts the TV program based on the adjustments.

Please refer to FIG. 4 and FIG. 5 together. The audio/video parameter tables 400, 500 contain the action mode, and the action mode has its own parameter values. The action movies usually have burst and dark scenes, therefore, to clearly show the detail of these scenes, the contrast must be enhanced. Moreover, the audio effect needs virtual surround and full bass to enhance burst scenes and impact on the user. Therefore, the action mode of the audio/video parameter table 400, 500 enhances those parameters. There are other modes in the audio/video parameter tables 400, 500 correspond to other movie profiles.

### Second Embodiment

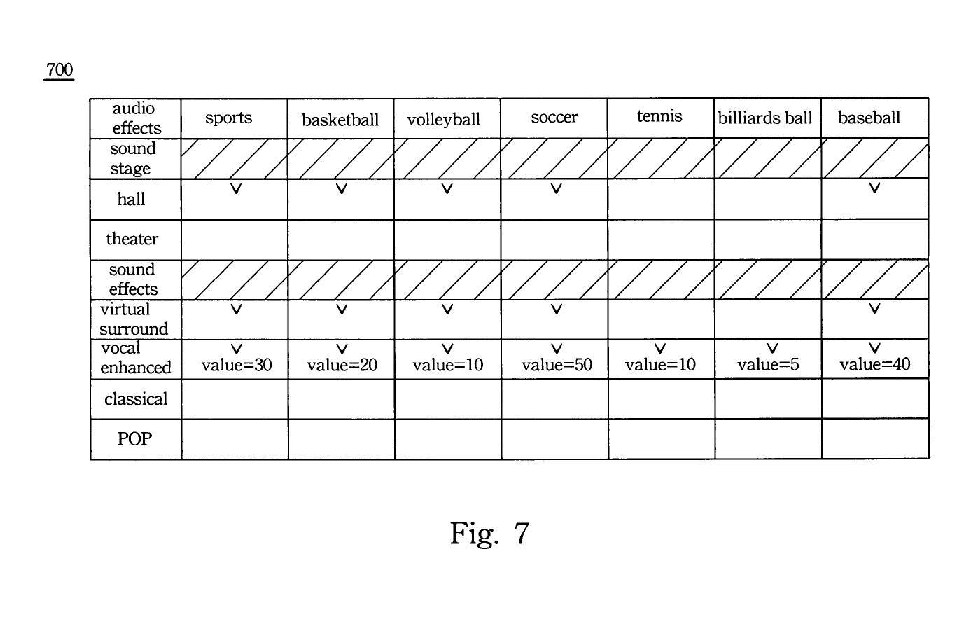

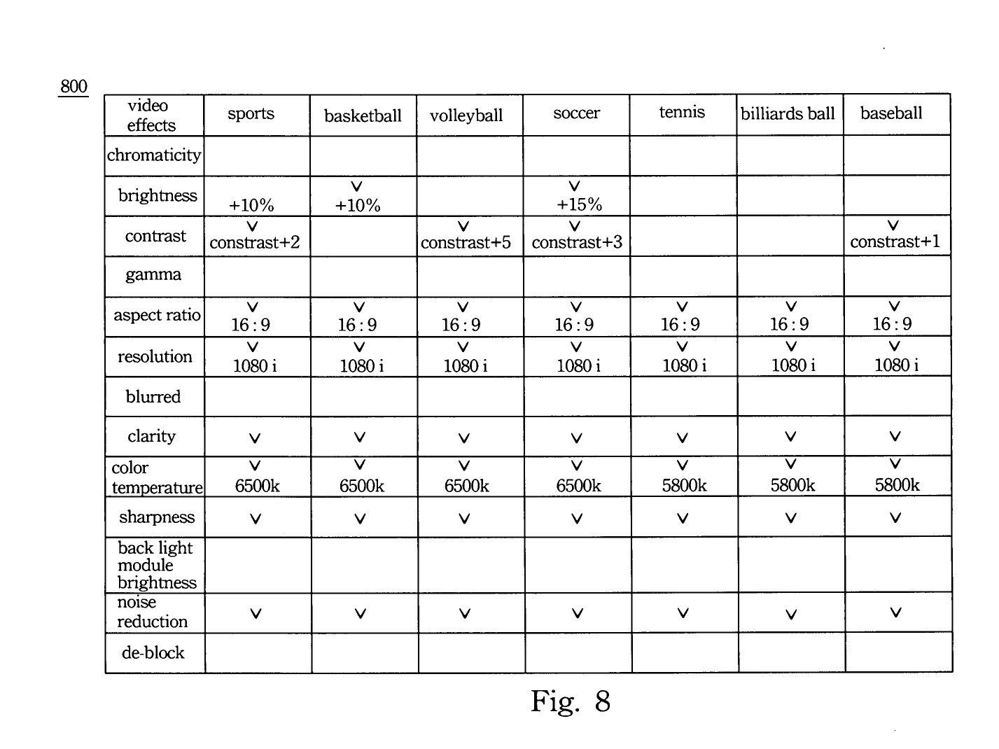

The method of this embodiment is almost the same as the first embodiment described above. Please refer to FIG. 7 and FIG. 8 together. This embodiment presumes that the digital TV program is a sports game. More particularly, the digital TV program is a soccer game. After the audio/video mapping unit receives the service information signal, the audio/video mapping unit decides that the digital TV program is a sports scenario based on the program information of the service information. Subsequently, the audio/video mapping unit retrieves the audio/video parameter tables 700, 800 of the sports scenario. There are many profiles in the sports scenario, for example, basketball, soccer, volleyball, and tennis. Therefore, the audio/video mapping unit further decides that the digital TV program is a soccer profile based on the program information. Then, the audio/video mapping unit retrieves the soccer mode audio/video parameter values from the audio/video parameter tables of the sport scenario. The audio/video parameter values are then substituted into the predetermined functions to obtain the adjustments. Finally, the audio/video processing unit adjusts the TV program based on the adjustments.

Please refer to FIG. 7 and FIG. 8 together. The audio/video parameter tables 700, 800 contain the soccer mode, and the soccer mode has its own parameter values. The audio effect can enhance the virtual surround and set in the hall effect of the sound stage. Moreover, it can enhance the distinct sound of the announcers from the sound of cheer. With the video effect, it can enhance the brightness and the sharpness to show the detail of the playground. Therefore, the soccer game mode of the audio/video parameter tables 700, 800 enhances those parameters. There are other modes in the audio/video parameter tables 700, 800 corresponding to other sports.

The DTV signal provider determines the internal information of the service information. Sometimes the program information of the service information provided for deciding the program type is not enough to decide the profile. Therefore, the audio/video parameter tables have a scenario mode which contains the specific scenario mode parameter values to adjust the audio/video signal. If the program information was not sufficient to decide the scenario, the audio/video parameter tables also contain a normal mode to adjust the audio/video signal generally.

The service information can contain amounts of information. Therefore, the service information may be compared with the parameter tables for more detail to obtain the more suitable parameter values for TV programs, if the parameter tables contain enough modes. Because the parameter tables are stored in the nonvolatile storage module, the categories of scenario, profile and the parameters can be augmented with the memory card from the memory slot which is arranged in the display apparatus. Furthermore, the audio/video mapping unit can be designed as a program and achieved in software or a firmware, or designed as a circuit and realized in hardware.

Many parameter categories can be contained in the parameter tables. For example, the video parameter tables at least contain parameters of Chromaticity, Brightness, Gamma, Contrast, Color temperature, Sharpness, Resolution, Aspect ratio, Noise reduction, and De-block. The audio parameter tables at least contain parameters of sound effects, and sound stage. Of course, the categories of video and audio parameters can be added or eliminated in the parameter tables depended on the designer of the display apparatus.

Moreover, the cooperation of the service information and the audio/video mapping unit is not only used to adjust the audio/video effect but also to adjust the brightness of the back light module based on the time information of the service information. The back light of the LCD display in different environment needs different brightness levels. In dark environment, the back light of the LCD display needs lower brightness levels; in bright environments, the back light of the LCD display needs higher brightness levels to show the scene. The display apparatus can contain a parameter table with the time and season. Therefore, the audio/video mapping unit can adjust the brightness level based on the time and season parameter table that cooperate with the date and time information of the service information.

For example, the weather is getting dark about at 17:30 to 18:30 in Taiwan in winter. The cooperation of the service information with the audio/mapping unit can adjust the brightness gradually according to the time and season parameter table. Therefore, energy can be saved and the life of the back light module increased. Furthermore, the other embodiment of the present invention can adjust other functions of the display apparatus based on the service information. The version of the invention is not limited to adjust the audio/video effect and not limited to use the program information of the service information only.

In view of foregoing, the various of the invention have advantages that the system can auto adjust the audio/video effect based on the service information to overcome the problem which is that too many mode choices could confuse the users and too few mode choices could not obtain the best feel about watching TV programs. Moreover, due to the DTV having superior image and audio quality, combined with the auto adjusting audio/video effect system of the present invention, can impact the visual and sound effects.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of adjusting audio/video effect, comprising the steps of:
receiving a digital TV signal, wherein the digital TV signal comprises at least one service information signal;
transmitting the service information signal to an audio/video mapping unit, and comparing the service information signal with at least one parameter table to obtain at least one audio/video parameter value; and
adjusting the digital TV signal based on the audio/video parameter value.

2. The method of claim 1, wherein the step of receiving a digital TV signal comprises demodulating and decoding the digital TV signal to a digital video signal, a digital audio signal, and the service information signal.

3. The method of claim 1, wherein the step of adjusting audio/video effect by the audio/video parameter comprises the steps of:
substituting the audio/video parameter value to a predetermined function to obtain at least one adjustment;
inputting the adjustment to an audio/video processing unit to adjust the digital TV signal.

4. The method of claim 3, wherein the audio/video processing unit comprises a multimedia processing unit and a video/audio post-processing unit.

5. The method of claim 1, wherein the audio/video mapping unit is a program, and is realized in software or a firmware.

6. The method of claim 1, wherein the audio/video mapping unit is a circuit, and is realized in hardware.

7. An adjusting audio/video effect system comprising:
a tuner with demodulator, capable of receiving and demodulating a digital TV signal, wherein the digital TV signal comprises a service information signal;
a DTV decoder, capable of decoding the demodulated digital TV signal to a digital video signal, a digital audio signal, and the service information signal;
an audio/video mapping unit, capable of receiving the service information signal, and comparing the service information signal with at least one parameter table to obtain at least one audio/video parameter value, and substituting the audio/video parameter value to at least one predetermined function to obtain at least one adjustment; and
an audio/video processing unit, capable of processing the digital video signal and the digital audio signal, and adjusting the digital video signal and the digital audio signal based on the adjustment.

8. The system of claim 7, wherein the DTV decoder further comprises:
a service information decoder, capable of decoding the service information signal.

9. The system of claim 7, wherein the audio/video mapping unit is a program, and is realized in software or firmware.

10. The system of claim 7, wherein the audio/video mapping unit is a circuit, and is realized in hardware.

11. The system of claim 7, wherein the adjusting audio/video effect system further comprises:
a nonvolatile storage module, capable of storing the parameter table and the predetermined function.

12. The system of claim 7, wherein the audio/video processing unit comprises a multimedia processing unit and a video/audio post-processing unit.

13. A method of adjusting audio/video effect, comprising the steps of:
receiving and demodulating a digital TV signal, wherein the digital TV signal comprises at least one service information signal;
decoding the demodulated digital TV signal to a digital video signal, a digital audio signal, and the service information signal;
transmitting the service information signal to an audio/video mapping unit, and transmitting the digital video signal and the digital audio signal to a audio/video processing unit;
comparing the service information signal with at least one parameter table to obtain at least one audio/video parameter value;
substituting the audio/video parameter value to at least one predetermined function to obtain at least one adjustment;
transmitting the adjustment to the audio/video processing unit, and adjusting the digital video signal and the digital audio signal based on the adjustment.

14. The method of claim 13, wherein the service information signal comprises at least one program information.

15. The method of claim 14, wherein the step of comparing the service information signal with at least one parameter table to obtain at least one audio/video parameter comprises the steps of:
comparing the program information with at least one scenario to decide a specific scenario;
comparing the program information with at least one profile of the specific scenario to decide a specific profile;
retrieving the audio/video parameter value from the parameter table corresponding to the specific profile.

16. The method of claim 13, wherein the audio/video mapping unit is a program, and is realized in software or firmware.

17. The method of claim 13, wherein the audio/video mapping unit is a circuit, and is realized in hardware.

18. The method of claim 13, wherein the audio/video unit comprises a multimedia processing unit and a video/audio post-processing unit.

19. The method of claim 13, wherein the service information signal further comprises a program association table, a program map table, a conditional access table, a network information table, a bouquet association table, a service description table, an event information table, a time and a date table, and a time offset table.

20. The method of claim 13, wherein the audio/video parameters at least comprises chromaticity, brightness, gamma, contrast, color temperature, sharpness, resolution, aspect ratio, back light module brightness, noise reduction, de-block, sound effects, sound stage.
